(19) United States
(12) Patent Application Publication
(10) Pub. No.: US 2014/0265326 A1
(43) Pub. Date: Sep. 18, 2014

(54) SYSTEM, METHOD, AND APPARATUS FOR GENERATING POWER FROM PRESSURIZED NATURAL GAS

(71) Applicant: Larry R. Allen, Big Piney, WY (US)

(72) Inventor: Larry R. Allen, Big Piney, WY (US)

(21) Appl. No.: 13/929,380

(22) Filed: Jun. 27, 2013

Related U.S. Application Data
(63) Continuation of application No. 13/924,311, filed on Jun. 21, 2013, now abandoned.
(60) Provisional application No. 61/784,739, filed on Mar. 14, 2013.

(51) Int. Cl. F01D 15/10; H02P 9/06; H02J 7/00; F01D 15/08

(52) U.S. Cl. CPC F01D 15/10; F01D 15/08; H02P 9/06; H02J 7/0021
USPC 290/7; 290/52; 320/137

(57) ABSTRACT

Embodiments of the present disclosure provide systems and apparatus for generating power from pressurized natural gas. The system may include an on-site pressure turbine for using some of the available energy of the pressurized natural gas to power an air compressor and/or electric generator. The turbine is driven by the expansion of natural gas due to a pressure differential and/or by the velocity of natural gas as it travels through a pipeline. In some embodiments, the turbine output is used to generate compressed air, which is used on-site to power pumps and switches. In some embodiments, the turbine output is used to generate electricity, which is then used on-site to power communications equipment and sensors. In some embodiments, a gear reduction system is used to adapt the turbine output to useful levels.

### RELATED APPLICATIONS

This application is a continuation of U.S. patent application Publication No. 13/924,311, filed on Jun. 21, 2013, entitled “System, Method, and Apparatus for Generating Power from Pressurized Natural Gas”, and which claims priority under 35 U.S.C. 119(e) to the U.S. Provisional Patent Application No. 61/784,739, filed on Mar. 14, 2013, and entitled “System and Apparatus for Generating Power From Pressurized Natural Gas”, all of which are herein incorporated by reference in their entireties.

### TECHNICAL FIELD

The present disclosure relates generally to generating on-site power at a natural gas field, and, more specifically, to using a natural gas pressure turbine to generate on-site power from the expansion of high pressure natural gas.

### SUMMARY

Embodiments of the present disclosure provide systems, methods, and apparatus for generating power from pressurized natural gas. In some embodiments, the system may include an on-site pressure turbine for using some of the available energy of the pressurized natural gas to power a compressor or electric generator. In such embodiments, the turbine is driven by the expansion of natural gas due to a pressure differential. The turbine may be placed anywhere in the flow lines between a natural gas well and a refinery, compressor station, cryogenic facility, or distribution center. For example, the turbine may be located on-site on the sales line, which transports natural gas to the refinery, compressor station, etc. In other embodiments, the turbine may be placed in a flare line to extract power from the pressurized natural gas before burning. In some embodiments, the turbine output is used to generate compressed air, which is then used on-site to power, e.g., pumps and switches. In some embodiments, the turbine output is used to generate electricity, which is then used to power, e.g., communications equipment and sensors. In some embodiments, a gear reduction system is used to adapt the turbine output to levels usable by the air compressor and/or electric generator.

The disclosed system includes a natural gas well for extracting natural gas, a natural gas pressure turbine configured to generate mechanical power by expanding the natural gas, an electric generator connected to the natural gas pressure turbine and configured to generate electrical power from the mechanical power, an electric power storage device connected to the electric generator and configured to store the generated electrical power, an air compressor connected to the natural gas pressure turbine and configured to generate compressed air form the mechanical power, an air storage device connected to the air compressor and configured to store the generated compressed air, and a distribution system connected to the electric power storage device and to the air storage device, wherein the distribution system provides compressed air from the air storage device to on-site equipment and provides electrical power from the electric power storage device to on-site equipment.

The system may further include one or more processing facilities connected to the natural gas well and configured to separate liquids from the extracted natural gas. These processing facilities are located on-site and are different from the refinery, compressor station, cryogenic facility, and/or distribution center mentioned above. The turbine may be co-located with the processing facilities, may be located upstream (i.e., towards the wellhead) of the processing facilities, or located downstream (towards the refinery or compressor station) of the processing facilities.

The system may further include a generator clutch located between the natural gas pressure turbine and the electric generator, the generator clutch configured to selectively decouple the electric generator from the mechanical power generated by the natural gas pressure turbine and/or a compressor clutch located between the natural gas pressure turbine and the air compressor, the compressor clutch configured to selectively decouple the air compressor from the mechanical power generated by the natural gas pressure turbine.

The system may further include a processor configured to monitor the natural gas pressure turbine, the electric generator, the air compressor, the electric power storage device, and the air storage device. The processor may monitor a pressure level of the air storage device, so as to actuate the compressor clutch to decouple the air compressor from the natural gas pressure turbine when the pressure level of the air storage device is at or above a predetermined upper air threshold and couple the air compressor to the natural gas pressure turbine when the pressure level of the air storage device is at or below a predetermined lower air threshold. The air storage device may comprise a plurality of air tanks and the processor may separately monitor and control the filling of each one of the plurality of air tanks.

The processor may also monitor a state-of-charge of the electric power storage device, so as to actuate the generator clutch to decouple the electric generator from the natural gas pressure turbine when the state-of-charge of the electric power storage device is at or above a predetermined upper electric threshold and couple the electric generator to the natural gas pressure turbine when the state-of-charge of the electric power storage device is at or below a predetermined lower electric threshold. The electric power storage device may comprise a plurality of rechargeable batteries and the processor may separately monitor and control charging of each one of the plurality of rechargeable batteries.

The system may also magnetically couple the natural gas pressure turbine to the electric generator and the air compressor. The system may include reduction gearing between the natural gas pressure turbine and the electric generator and/or air compressor. Additionally, the system may include a temperature normalizer that exchanges heat among the natural gas pressure turbine, the electric generator, the electric storage device, the air compressor, and/or the air storage device. The heat produced by the electric generator, the electric storage device, the air compressor, and/or the air storage device would be transferred to the pressure turbine to offset the temperature drop cause by gas expansion. Said differently, the temperature drop experienced by the expanding natural gas may be used to cool the electric generator, the electric storage device, the air compressor, and/or the air storage device.

The disclosed method for generating on-site power includes the steps of: extracting natural gas and associated liquids; sending the natural gas to a pressure differential turbine; extracting mechanical power, via the pressure differential turbine, from a pressure differential of the natural gas; generating electrical power from the extracted mechanical power; storing the electrical power in an electric power storage device; producing compressed air from the extracted mechanical power; storing the compressed air in an air storage device; and distributing the electrical power or compressed air to on-site equipment. The compressed air may be produced by an air compressor and the electric power may be generated by an electric generator. The method may also include steps of separating the natural gas from the associated liquids and drying the natural gas. The method may further include selectively coupling the air compressor and/or electric generator to the natural gas pressure turbine.

The method may include monitoring the natural gas pressure turbine, the electric generator, the air compressor, the electric power storage device, and the air storage device. The pressure levels of the air storage device and the state-of-charge of the electric power storage device may be monitored to control the coupling of the air compressor and/or electric generator to the natural gas pressure turbine. The method may include decoupling the air compressor when the pressure level of the air storage device is at or above a predetermined upper air threshold and coupling the air compressor when the pressure level of the air storage device is at or below a predetermined lower air threshold. The method may also include decoupling the electric generator when the state-of-charge of the electric power storage device is at or above a predetermined upper electric threshold and coupling the electric generator to the natural gas pressure turbine when the state-of-charge of the electric power storage device is at or below a predetermined lower electric threshold.

The method may further include magnetically coupling the natural gas pressure turbine to the electric generator and the air compressor. The method may include reducing the rate of rotation between the natural gas pressure turbine and the electric generator and/or air compressor. Additionally, the method may include exchanging heat among the natural gas pressure turbine, the electric generator, the electric storage device, the air compressor, and/or the air storage device. The heat produced by the electric generator, the electric storage device, the air compressor, and/or the air storage device may be transferred to the pressure turbine to offset the temperature drop cause by gas expansion. Said differently, the temperature drop experienced by the expanding natural gas may be used to cool the electric generator, the electric storage device, the air compressor, and/or the air storage device.

The method may include adapting an electrical input into an electrical output, wherein the electrical input varies from the electrical output in at least one of voltage, current, and waveform. For example, the electrical input may be the electric power generated from the extracted mechanical power and the electrical output may be an output voltage, an output current, and an output waveform useable by the on-site equipment or by the electric power storage device. As another example, the electrical input may be the electric power produced by the electric power storage device and the electrical output may be an output voltage, an output current, and an output waveform useable by the on-site equipment.

The disclosed apparatus for generating on-site power at a natural gas field may comprise a natural gas pressure turbine configured to receive pressurized natural gas and to generate mechanical power by expanding the natural gas, an electric generator connected to the natural gas pressure turbine and configured to generate electrical power from the mechanical power, an air compressor connected to the natural gas pressure turbine and configured to generate compressed air form the mechanical power, an electric power storage device connected to the electric generator and configured to store the generated electrical power; and an air storage device connected to the air compressor and configured to store the generated compressed air.

Additional aspects and advantages will be apparent from the following detailed description of preferred embodiments, which proceeds with reference to the accompanying drawings.

### BRIEF DESCRIPTION OF THE DRAWINGS

FIG. 1 is a block diagram of a remote site and a system for generating on-site power from pressurized natural gas, according to embodiments of the disclosure.

FIG. 2 is a block diagram of a pressure differential power generation system for use at a remote site, according to embodiments of the disclosure.

FIG. 3A is a cut-away, perspective view of a natural gas pressure turbine assembly, according to embodiments of the disclosure.

FIG. 3B is a perspective view of the natural gas pressure turbine assembly of FIG. 3A, according to embodiments of the disclosure.

FIG. 3C is a perspective view of an impeller of the natural gas pressure turbine assembly of FIG. 3A, according to embodiments of the disclosure.

FIG. 4 is a cut-away, perspective view of a pressure differential power generating system comprising a natural gas pressure turbine and a power generator, according to embodiments of the disclosure.

FIG. 5A is a perspective view of a pressure differential power generating system comprising a natural gas pressure turbine, an electrical generator, and an air compressor, according to embodiments of the disclosure.

FIG. 5B is an exploded, perspective view of the pressure differential power generating system of FIG. 5A, according to embodiments of the disclosure.

FIG. 6 is a perspective view of a pressure differential power generating system comprising a natural gas pressure turbine having a magnetic coupling mechanism, according to embodiments of the disclosure.

FIG. 7A is a front view of a pressure differential turbine body, according to embodiments of the disclosure.

FIG. 7B is a cut-away, side view of the pressure differential turbine body of FIG. 7A, according to embodiments of the disclosure.

FIG. 7C is a different cut-away, side view of the pressure differential turbine body of FIG. 7A, according to embodiments of the disclosure.

FIG. 7D is a different cut-away, side view of the pressure differential turbine body of FIG. 7A, according to embodiments of the disclosure.

FIG. 7E is a different cut-away, side view of the pressure differential turbine body of FIG. 7A, according to embodiments of the disclosure.

FIG. 7F is a perspective view of the pressure differential turbine body of FIG. 7A, according to embodiments of the disclosure.

FIG. 8 is a block diagram of a remote site and a system for generating on-site power from a flare line, according to embodiments of the disclosure.

### DETAILED DESCRIPTION OF PREFERRED EMBODIMENTS

Natural gas is an important energy source used worldwide. Natural gas may be consumed for power generation, as a heating, cooking, or vehicular fuel, or as a chemical feedstock in the production of plastics and other organic compounds.

Natural gas is extracted from deposits or reservoirs deep in the earth. Deposits rich in natural gas are commonly referred to as natural gas “fields”. Natural gas may also be found in significant quantities in oil fields or coal beds. To extract natural gas from a natural gas field, a well is drilled from the surface to the deposit or reservoir. Natural gas from the wellhead is processed to remove condensates, water, and impurities or contaminants. Additionally, the natural gas may be further processed to separate the different hydrocarbons that form natural gas.

Typically, active natural gas fields are quite remote and far removed from the electrical grid. Consequently, there is a need to generate power at or near the remote site (i.e., the natural gas well and processing facilities) to power the machinery, facilities, and processes used to extract and process the natural gas. A conventional solution is to build a natural gas-fired power station near the remote site to generate power to satisfy the remote site's needs. However, the conventional solution has many drawbacks, including consumption of otherwise sellable natural gas and atmospheric emissions due to the combustion of natural gas. Due to the health and environmental risks caused by the emissions from natural gas combustion, many governmental agencies regulate the use of natural gas-fired power stations at or near natural gas fields. Additionally, the costs of power generation and transmission increase the further the power station is to the remote site.

As the deposits and reservoirs are deep below the Earth's surface, the natural gas contained therein is under enormous pressure. The natural gas must undergo pressure reduction before it can be delivered to customers. Disclosed are systems and methods for harnessing the pressure differential between the high pressure natural gas and the lower pressure, sales-line natural gas to generate power for the remote site. The disclosed power solution improves on conventional solutions as power generation no longer requires the combustion of natural gas and/or venting gas into the atmosphere. Beneficially, all the natural gas extracted from a well may be sold to customers and no natural gas or combustion byproducts are released (e.g., vented) into the atmosphere.

The disclosed on-site power solution is environmentally friendly, as it results in fewer air emissions as compared to conventional on-site power generators. The reduced emissions not only improve air quality and smell, but also improve worker health, as the operators and maintenance workers servicing the remote site do not inhale combustion products or gaseous well products, including natural gas. Additional environmental benefits of the present invention include improved water quality and reduced destruction of wildlife habitat as the remote site operator no longer requires the construction of miles of power lines leading to the remote site. The reduced power line need also reduces the initial and operating costs of the remote site. Further, the on-site power generation is cost effective, as it results in more saleable product as compared to conventional on-site power generators.

Embodiments of the present disclosure provide systems, methods, and apparatus for generating power from pressurized natural gas. In some embodiments, the system may include an on-site pressure turbine for using some of the available energy of the pressurized natural gas to power a compressor and/or electric generator. In such embodiments, the turbine is driven by the expansion of natural gas due to a pressure differential. The turbine may be placed anywhere in the flow lines between a natural gas well and a refinery, compressor station, cryogenic facility, or distribution center. For example, the turbine may be located on-site on the sales line, which transports natural gas to the refinery, compressor station, etc. In other embodiments, the turbine may be placed in a flare line to extract power from the pressurized natural gas before burning. In some embodiments, the turbine output is used to generate compressed air, which is then used on-site to power, e.g., pumps and switches. In some embodiments, the turbine output is used to generate electricity, which is then used to power, e.g., communications equipment and sensors. In some embodiments, a gear reduction system is used to adapt the turbine output to levels usable by the air compressor and/or electric generator.

The disclosed system includes a natural gas well for extracting natural gas, a natural gas pressure turbine configured to generate mechanical power through the expansion of the natural gas, an electric generator connected to the natural gas pressure turbine and configured to generate electrical power from the mechanical power, an electric power storage device connected to the electric generator and configured to store the generated electrical power, an air compressor connected to the natural gas pressure turbine and configured to generate compressed air form the mechanical power, an air storage device connected to the air compressor and configured to store the generated compressed air, and a distribution system connected to the electric power storage device and to the air storage device, wherein the distribution system provides compressed air from the air storage device to on-site equipment and provides electrical power from the electric power storage device to on-site equipment.

The system may further include one or more processing facilities connected to the natural gas well and configured to separate liquids from the extracted natural gas. These processing facilities are located on-site and are different from the refinery, compressor station, cryogenic facility, and/or distribution center mentioned above. The turbine may be co-located with the processing facilities, may be located upstream (i.e., towards the wellhead) of the processing facilities, or located downstream (towards the refinery or compressor station) of the processing facilities.

The system may further include a generator clutch located between the natural gas pressure turbine and the electric generator, the generator clutch configured to selectively decouple the electric generator from the mechanical power generated by the natural gas pressure turbine and/or a compressor clutch located between the natural gas pressure turbine and the air compressor, the compressor clutch configured to selectively decouple the air compressor from the mechanical power generated by the natural gas pressure turbine.

The system may further include a processor configured to monitor the natural gas pressure turbine, the electric generator, the air compressor, the electric power storage device, and the air storage device. The processor may monitor a pressure level of the air storage device, so as to actuate the compressor clutch to decouple the air compressor from the natural gas pressure turbine when the pressure level of the air storage device is at or above a predetermined upper air threshold and couple the air compressor to the natural gas pressure turbine when the pressure level of the air storage device is at or below a predetermined lower air threshold. The air storage device may comprise a plurality of air tanks and the processor may separately monitor and control the filling of each one of the plurality of air tanks.

The processor may also monitor a state-of-charge of the electric power storage device, so as to actuate the generator clutch to decouple the electric generator from the natural gas pressure turbine when the state-of-charge of the electric power storage device is at or above a predetermined upper electric threshold and couple the electric generator to the natural gas pressure turbine when the state-of-charge of the electric power storage device is at or below a predetermined lower electric threshold. The electric power storage device may comprise a plurality of rechargeable batteries and the processor may separately monitor and control charging of each one of the plurality of rechargeable batteries.

The system may also magnetically couple the natural gas pressure turbine to the electric generator and the air compressor. The system may include reduction gearing between the natural gas pressure turbine and the electric generator and/or air compressor. Additionally, the system may include a temperature normalizer that exchanges heat among the natural gas pressure turbine, the electric generator, the electric storage device, the air compressor, and/or the air storage device. The heat produced by the electric generator, the electric storage device, the air compressor, and/or the air storage device would be transferred to the pressure turbine to offset the temperature drop cause by gas expansion. Said differently, the temperature drop experienced by the expanding natural gas may be used to cool the electric generator, the electric storage device, the air compressor, and/or the air storage device.

The disclosed method for generating on-site power includes the steps of: extracting natural gas and associated liquids; sending the natural gas to a pressure differential turbine; extracting mechanical power, via the pressure differential turbine, from a pressure differential of the natural gas; generating electrical power from the extracted mechanical power; storing the electrical power in an electric power storage device; producing compressed air from the extracted mechanical power; storing the compressed air in an air storage device; and distributing the electrical power or compressed air to on-site equipment. The compressed air may be produced by an air compressor and the electric power may be generated by an electric generator. The method may also include steps of separating the natural gas from the associated liquids and drying the natural gas. The method may further include selectively coupling the air compressor and/or electric generator to the natural gas pressure turbine.

The method may include monitoring the natural gas pressure turbine, the electric generator, the air compressor, the electric power storage device, and the air storage device. The pressure levels of the air storage device and the state-of-charge of the electric power storage device may be monitored to control the coupling of the air compressor and/or electric generator to the natural gas pressure turbine. The method may include decoupling the air compressor when the pressure level of the air storage device is at or above a predetermined upper air threshold and coupling the air compressor when the pressure level of the air storage device is at or below a predetermined lower air threshold. The method may also include decoupling the electric generator when the state-of-charge of the electric power storage device is at or above a predetermined upper electric threshold and coupling the electric generator to the natural gas pressure turbine when the state-of-charge of the electric power storage device is at or below a predetermined lower electric threshold.

The method may further include magnetically coupling the natural gas pressure turbine to the electric generator and the air compressor. The method may include reducing the rate of rotation between the natural gas pressure turbine and the electric generator and/or air compressor. Additionally, the method may include exchanging heat among the natural gas pressure turbine, the electric generator, the electric storage device, the air compressor, and/or the air storage device. The heat produced by the electric generator, the electric storage device, the air compressor, and/or the air storage device may be transferred to the pressure turbine to offset the temperature drop cause by gas expansion. Said differently, the temperature drop experienced by the expanding natural gas may be used to cool the electric generator, the electric storage device, the air compressor, and/or the air storage device.

The method may include adapting an electrical input into an electrical output, wherein the electrical input varies from the electrical output in at least one of voltage, current, and waveform. For example, the electrical input may be the electric power generated from the extracted mechanical power and the electrical output may be an output voltage, an output current, and an output waveform useable by the on-site equipment or by the electric power storage device. As another example, the electrical input may be the electric power produced by the electric power storage device and the electrical output may be an output voltage, an output current, and an output waveform useable by the on-site equipment.

The disclosed apparatus for generating on-site power may comprise a pressure differential turbine that converts energy of the pressurized natural gas, in the form of a pressure differential and/or velocity, into mechanical energy. In some embodiments, the apparatus may further comprise a power generator attached to the pressure differential turbine for converting the mechanical energy into an energy form usable to power on-site equipment. For example, the apparatus may comprise an electric generator connected to the natural gas pressure turbine and configured to generate electrical power from the mechanical power and an air compressor connected to the natural gas pressure turbine and configured to generate compressed air form the mechanical power. Additionally, the apparatus may comprise one or more on-site power storage devices that store power generated by the turbine for future use. For example, the apparatus may comprise an electric power storage device (connected to an electric generator) for storing generated electrical power and an air storage device (connected to an air compressor) for storing generated compressed air. In some embodiments, a gear reduction system may be used to adapt the turbine output to useful levels.

Embodiments may be best understood by reference to the drawings. It will be readily understood that the components of the present disclosure, as generally described and illustrated in the drawings herein, could be arranged and designed in a wide variety of different configurations. Thus, the following more detailed descriptions of the systems and methods are not intended to limit the scope of the disclosure, but are merely representative of possible embodiments of the disclosure. In some cases, well-known structures, materials, or operations are not shown or described in detail.

As used herein, the term “remote site” refers to the site where the natural gas and/or oil is extracted and processed. A remote site may be located onshore or offshore. For example, the remote site may comprise a conventional natural gas well or a shale gas well located on land. As another example, the remote site may comprise an offshore platform (fixed or floating) operating in coastal or deep waters. The remote site well may comprise a natural gas well, a natural gas condensate well, or an oil well that contains associated natural gas.

FIG. 1 is a block diagram of a system 100 for generating power from pressurized natural gas at a remote site according to embodiments of the disclosure. The system 100 is located at a natural gas field and comprises a well and wellhead 110, a contact tower 120, a production unit 130, a backpressure control valve 140, and a pressure turbine power generator 150. The system 100 comprises a power distribution grid 155 used to distribute power generated by the pressure turbine power generator 150 to the wellhead 110, the contact tower 120, and the production unit 130. Natural gas is extracted from underground deposits using the wellhead 110. The wellhead 110 may be any well suitable for extracting natural gas. For example, the wellhead 110 may be a natural gas well, a natural gas condensate well, or an oil well that contains associated natural gas. While the discussion of FIG. 1 generally assumes that natural gas and associated natural gas liquids (e.g., ethane, propane, butane, etc.) are extracted from the wellhead 110, in other embodiments crude oil and associated natural gas may be extracted. After extraction and separation, saleable products (i.e., natural gas, natural gas liquids, crude oil, etc.) are transported via pipeline to one or more processing facilities 160. The pressure turbine power generator 150 may be placed anywhere between the wellhead 110 and the processing facilities 160 in order to extract power from the pressurized natural gas.

The contact tower 120 is configured to dry (i.e., to remove water from) the natural gas extracted by the wellhead 110. While liquid water may be easily separated from the natural gas, water vapor may be remove by absorption by a dehydrating agent, or by condensing and collecting the vapor. The production unit 130 is configured to process the natural gas by separating condensates (liquids) from the natural gas. In some embodiments, the production unit 130 further processes the natural gas by separating and/or extracting various hydrocarbons, including natural gas liquids such as methane, butane, etc. Although the system 100 is depicted as drying the natural gas before processing it, in some embodiments, the natural gas extracted by the wellhead 110 is processed at the production unit 130 before being dried at the contact tower 120. Additionally, in some embodiments, the functions of the production unit 130 are distributed among various locations. For example, oil or condensates may be separated from the natural gas at or near the wellhead 110, while impurities (including water) may be removed after separating the natural gas. In some embodiments, the contact tower 120 and the production unit 130 are co-located, so that both drying and processing occur at the same facility.

The natural gas leaves the remote site and is transported to processing facility 160 via sales line 162. The sales line 162 is a transportation pipeline for carrying the extracted and separated natural gas that comprises a sales meter for determining the amount of product (e.g., natural gas) produced by the remote site and placed into the sales line 162. The processing facility 160 may be a refinery, cryogenic facility, compressor station, or distribution center. The processing facility 160 receives the natural gas liquids or other product and prepares (purifies) it for commercial distribution. Depending on the composition of the extracted natural gas and on consumer needs, the processing facility 160 may remove contaminants, such as hydrogen sulfide, carbon dioxide, or similar acidic gases. The processing facility may also remove trace metals (e.g., mercury) and nitrogen from the natural gas. The purified natural gas is then transported to the end-user (consumer). While not shown in FIG. 1, the system 100 may include additional pipelines for transporting natural gas liquids and/or crude oil off-site to processing facilities.

The system 100 further comprises a plurality of natural gas pipelines 112 used to transport natural gas between the wellhead 110, the contact tower 120, the production unit 130, the backpressure control valve 140, the pressure turbine power generator 150, and the sales meter 160. The system 100 may further comprise a power storage device 152 and/or one or more flare lines (not shown) leading from the wellhead 110, the contact tower 120, and/or the production unit gas 130 into which is released via pressure relief valves whenever the wellhead 110, the contact tower 120, or the production unit 130 become over-pressured. While the pressure turbine power generator 150 is shown in FIG. 1 as being connected to natural gas pipeline 142, in other embodiments the pressure turbine power generator 150 may be connected to the contact tower 120 via natural gas pipeline 122, to the production unit 130 via natural gas pipeline 132, or even to the wellhead 110 via natural gas pipeline 112. In other embodiments, the turbine may be placed on a flare line to extract power from the expansion of pressurized natural gas vented into the flare line via a pressure relief valve. Additionally, while FIG. 1 shows the system 100 comprising a single pressure turbine power generator 150, in some embodiments the system 100 comprises more than one pressure turbine power generators. For example, the system 100 may comprise a pressure turbine power generator 150 connected to the backpressure control valve 140 and an additional natural gas pressure turbine connected to a flare line or incinerator. The additional pressure turbine would be capable of extracting power from a pressure differential in off-gas before it is burned similar to the pressure turbine power generator 850 discussed below with reference to FIG. 8. As another example, the system 100 may comprise a first pressure turbine power generator located between the wellhead 110 and the production unit 130 and a second pressure turbine power generator located between the production unit 130 and the processing facility 160. The first pressure turbine would reduce natural gas pressure before reaching the production unit 130 similar to chokes used in conventional systems. Additionally, instead of a single turbine power generator, the pressure turbine power generator 150 may comprise two or more pressure turbine power generators arranged in series or in parallel.

The backpressure control valve 140 is a control valve or regulator configured to maintain a certain upstream pressure in the system 100. In some embodiments, the backpressure control valve 140 is used to ensure that the drying and processing of natural gas, via the contact tower 120 and the production unit 130, occurs at a particular pressure level. In certain embodiments, excess pressure in the system 100 may be relieved by venting natural gas through the backpressure control valve 140 and into the pressure turbine power generator 150. In some embodiments, the backpressure control valve 140 prevents uncontrolled flow of natural gas through the system 100. In such embodiments, the backpressure control valve 140 may be used to ensure that the pressure turbine power generator 150 does not operate at unsafe pressure levels and/or to control the flow of natural gas into the sales line 162. The backpressure control valve 140 may operate in conjunction with one or more check valves to prevent back flow of natural gas within the system 100.

The pressure turbine power generator 150 is configured to generate power from the expansion of natural gas as it passes from a high-pressure region to a low-pressure region. The pressure turbine power generator 150 does not combust the natural gas to generate power and neither natural gas nor combustion byproducts are released into the atmosphere by the pressure turbine power generator 150. This allows for more natural gas to be sold from a site as compared to conventional methods where a portion of the extracted natural gas is siphoned off to be combusted for on-site power generation. Instead, in the system 100, the pressure turbine power generator 150 harnesses the pressure differential between the inlet and outlet of the natural gas pressure turbine 150 to spin the turbine blades thereby generating power while delivering the natural gas to the sales line 162. Additional details of the pressure turbine power generator 150 are discussed below in reference to FIGS. 2, 3A-3C, FIG. 4, FIG. 5A-5B and FIG. 6.

The pressure turbine power generator 150 may generate mechanical and/or electrical power. In certain embodiments, an output shaft of the pressure turbine power generator 150 drives an air compressor for producing compressed air for use in the system 100. The compressed air may be used on-site to power, among other things, pumps and switches. The compressed air may be used to replace and/or supplement natural gas that is conventionally bled off from the system 100 and used on site. In certain embodiments, an output shaft of the pressure turbine power generator 150 drives an electric generator used to power, among other things, communications equipment, process controllers, and sensors. The electricity generated by pressure turbine power generator 150 may be used to replace and/or supplement electricity generated on-site by other means, including natural-gas fired generators, solar panels, wind turbines, and the like. In certain embodiments, the pressure turbine power generator 150 drives a hydraulic pump used to power pumps or other machinery. In some embodiments, the pressure turbine 150 power generator drives two or more of: an electrical generator, a hydraulic pump, and an air compressor.

The pressure turbine power generator 150 may directly drive a generator or compressor, or may indirectly drive the generator or compressor, for example, through the use of gearboxes, belts, chains, or the like. In some embodiments, the pressure turbine power generator 150 may spin at a high rate due to the large pressure differential of the natural gas between the inlet and outlet of the natural gas pressure turbine 150. In such embodiments, the natural gas pressure turbine power generator 150 may comprise a rate reduction system that adapts the turbine shaft output to useful levels. For example, if the expansion of natural gas causes the natural gas pressure turbine 150 to turn at, e.g., 100,000 RPM, a gearbox, belt and pulley device, or other rate reduction system may be used to turn an electrical generator at an efficient rate, e.g., 3,600 RPM. Further, where the output shaft of the natural gas pressure turbine 150 is used to drive both an electrical generator and an air compressor, a different reduction ratio may be used with the electrical generator than with the air compressor.

In some embodiments, excess power generated by the pressure turbine power generator 150 is stored in power storage device 152. The power storage device 152 may be configured to store electrical power or compressed air in accordance with what produced by the pressure turbine power generator 150. For example, the power storage device 152 may comprise batteries and/or capacitors for storing electrical power. Alternatively, or additionally, the power storage device may comprise one or more tank for holding compressed air. The power storage device 152 allows the system 100 to potentially use larger amounts of electricity or compressed air than the instantaneous output of the pressure turbine power generator 150. Thus, where power consumption is irregular or cyclical, the power storage device 152 allows the system 100 use a smaller pressure turbine power generator 150, while still being capable of meeting peak loads.

FIG. 2 shows a block diagram of a pressure differential power generating system 200 according to embodiments of the disclosure. The pressure differential power generating system 200 generates on-site power at an oil or natural gas field using a pressure differential of natural gas. The pressure differential power generating system 200 comprises a high pressure natural gas line 202 and a low pressure natural gas line 204. A pressure differential turbine 210 is located between the high pressure natural gas line 202 and the low pressure natural gas line 204 and connects the high pressure natural gas line 202 to the low pressure natural gas line 204. The pressure levels of the high pressure gas line 202 are monitored via pressure transducer 203. Although not shown, the pressure levels of the low pressure natural gas line 204 also may be monitored via pressure transducer. Further, in certain embodiments the pressure transducer(s) may also be used to monitor other characteristics of the natural gas lines including temperature and flow rates.

The pressure differential turbine 210 uses some of the available energy of the pressurized natural gas to power an air compressor 220 and an electric generator 230. The pressure differential turbine 210 is connected to the air compressor 220 via a clutch 216 and to the electric generator 230 via a clutch 218. In some embodiments, the clutches 216, 218 are actuated pneumatically (e.g., by compressed air generated by air compressor 220), electrically (e.g., by electricity generated by electric generator 230), or hydraulically (e.g., by hydraulic fluid pumped using kinetic energy from the pressure differential turbine 210). In some embodiments, the pressure differential turbine 210 is also connected to the air compressor 220 and to the electric generator 230 via a speed reduction device 214. The speed reduction device 214 may be any device suitable for reducing the relatively high rotation rate of the pressure differential turbine 210 to ranges suitable for use by the air compressor 220 and/or the electric generator 230. Examples of speed reduction devices include, but are not limited to, gearboxes, belt drives, chain drives, and the like. Additionally, the pressure differential power generating system 200 may comprise a brake 212 used to reduce the speed of the pressure differential turbine 210 should the rate get too high. Additionally, the brake 212 may be used to shut down the pressure differential turbine 210 in the event of an emergency.

The pressure differential power generating system 200 is monitored and controlled by a controller 240. The controller 240 may comprise one or more microprocessors, programmable logic devices, integrated circuits, or other computer controllers. The controller 240 comprises computer-readable memory (volatile and/or non-volatile) or other data storage devices that hold instructions for operating the pressure differential power generating system 200 and parameters or data associated with the operation of the pressure differential power generating system 200. For example, the controller 240 may comprise non-transitory computer readable storage media, including, but not limited to, random access memory (RAM), read-only memory (ROM), flash memory, magnetic storage devices—such as floppy discs or hard-disc drives, and optical storage devices—such as compact discs (CDs), video discs (e.g., DVDs), and holographic storage devices. The computer-readable memory may contain software, firmware, and data structures necessary for the operation of the pressure differential power generating system 200. Further, the computer-readable memory may store data relating to the performance of the components of the pressure differential power generating system 200. For example, the computer-readable memory may store data indicative of the temperature of components (e.g., the pressure differential turbine 210 or the electric generator 230) of the pressure differential power generating system 200, so that the pressure differential power generating system 200 may be shut down if it begins to overheat. As another example, the computer-readable memory may store data relating to natural gas pressure as it passes through the pressure differential power generating system 200.

The controller 240 monitors pressures in the pressure differential power generating system 200 via at least pressure transducers 203, 223. In some embodiments, the pressure transducers 203, 223 are also used to monitor the temperature of the natural gas or compressed air. The controller 240 may also be electrically connected to other sensors in the pressure differential power generating system 200 for monitoring system parameters, e.g., temperature, pressure, and flow rates. In some embodiments, the controller 240 monitors the time that equipment (e.g., air compressor 220) has been running to aid in the regular maintenance of the pressure differential power generating system 200. The controller 240 communicates with sensors (e.g., pressure transducers 203, 223) via communication bus 241.

The controller 240 controls the pressure differential power generating system 200 via actuators 242, 244, and 246. Actuator 242 activates and deactivates the brake 212. Actuator 244 activates and deactivates the clutch 216. Actuator 246 activates and deactivates the clutch 218. While FIG. 2 shows the actuators 242, 244, and 246 being electrically actuated, in other embodiments the actuators 242, 244, and 246 may be pneumatically or hydraulically actuated. In some embodiments, the actuators 242, 244, and 246 may be configured to measure operating parameters, such as temperature, of the brake 212 or clutches 216, 218. The controller 240 communicates with the actuators 242, 244, and 246 via the communication bus 241.

Air compressor 220 is configured to use mechanical power (i.e., rotary motion) received from the pressure differential turbine 210 to compress air. Compressed air is distributed to compressed air storage device 222, which stores the compressed air for use by external devices 224. The pressure of air generated by the air compressor 220 may be determined by the needs of external devices 224 and/or the capabilities of the compressed air storage device 222. In some embodiments, the pressure levels generated by the air compressor 220 are adjustable. For example, the pressure levels may be computer controlled and dynamically adjustable. In some embodiments, the compressed air storage device 222 comprises one or more air tanks, valves, and pressure regulators to control the introduction and release of compressed air into the air tank(s). The volume of the compressed air storage device 222 may be determined according to the needs of the remote site. For example, where the natural gas is extracted cyclically (i.e., on an “on-off” cycle) the compressed air storage device 222 may store compressed air during an active (“on”) cycle for use on-site during an inactive (“off”) cycle. As another example, the compressed air storage device 222 may have sufficient capacity to provide a “buffer” for peak compressed air demands, so that the air compressor 220 output need only meet the average equipment requirements of the remote site. Although not shown in FIG. 2, the brake 212 and the clutches 216, 218 may be supplied with compressed air generated from the air compressor 220 and/or stored in the compressed air storage device 222 for pneumatic actuation. In some embodiments, the pressure differential power generating system 200 comprises a pressure transducer 223 for monitoring the pressure levels within the compressed air storage device 222.

The controller 240 may control the clutch 216 according to pressure levels of the compressed air storage device 222. When the pressure level of the compressed air storage device 222 reaches or drops below a lower air threshold (e.g., when the compressed air storage device 222 is depleted), the clutch 216 may be actuated to couple (or re-couple) the air compressor 220 to the pressure differential turbine 210 output. Additionally, when the pressure level of the compressed air storage device 222 reaches or exceeds an upper air threshold (e.g., when the compressed air storage device 222 is full), the clutch 216 may be actuated to decouple the air compressor 220 from the pressure differential turbine 210 output. Decoupling may improve the lifespan of the air compressor 220 (as it is not constantly running). The upper and lower air thresholds may be predetermined or may be dynamically selected. Additionally, the thresholds may be set by the manufacturer or may be set by the user (i.e., by the natural gas site operator). Where the compressed air storage device 222 comprises a plurality of air tanks (or other suitable air storage devices), the controller 240 may be configured to separately monitor and control the charging of each one of the air tanks. The clutch 216 may be actuated according to the needs of a single air tank, a majority of the air tanks, or all of the air tanks, according to user preference and site needs. For example, the air compressor 220 may be decoupled from the pressure differential turbine 210 once the pressure level of each one of the air tanks reaches the upper air threshold or, alternatively, may be decoupled when the pressure level of any one of the air tanks reaches the upper air threshold. As another example, the air compressor 220 may be coupled to the pressure differential turbine 210 when the pressure level of each one of the air tanks reaches the lower air threshold or, alternatively, may be coupled when the pressure level of any one of the air tanks reaches the lower air threshold.

The electric generator 230 is configured to use mechanical power (i.e., rotary motion) received from the pressure differential turbine 210 to generate electric power (i.e., electricity). In some embodiments, AC power is generated by the electric generator 230. In other embodiments, DC power is generated by the electric generator 230. The waveform, voltage, and/or current of the generated electric power may be selected according to the requirements of the pressure differential power generating system 200 and of external equipment 238. In some embodiments, the pressure differential power generating system 200 comprises a power conditioner 232 connected to the electric generator 230. The power conditioner 232 is configured to transform an electrical input (e.g., a waveform, voltage, and current) into an electrical output that differs in waveform, voltage, and/or current. The input may be electricity from the electric generator 230 or from an electrical storage device 234. The output may be selected according to the requirements of the electrical storage device 234, the pressure differential power generating system 200, or of an external equipment 238 (e.g., an on-site pump or switch). For example, pressure transducers 203, 223 may require relatively low voltages and currents while external equipment 238 (e.g., processing equipment at the remote site) may require much higher voltages and currents. In this situation, the electric generator 230 may be configured to generate the high voltages and currents required by the external equipment 238, while the power conditioner 232 adapts some of the high voltage, high current electrical power into the lower voltage and current power used by the pressure transducers 203, 223.

The electric generator 230 and/or the power conditioner 232 are electrically connected to an electrical storage device 234. The electrical storage device 234 may comprise one or more batteries, capacitors, or other electrical energy storage apparatus. In some embodiments, the electrical storage device 234 also comprises a charge controller for regulating the rate at which electrical current is added to or drawn from the electrical storage device 234, while, in other embodiments, the controller 240 may act as a charge controller. The amount of electrical energy capable of being stored in the electrical storage device 234 may be determined according to the needs of the remote site. For example, where the natural gas is extracted cyclically (i.e., on an “on-off” cycle) the electrical storage device 234 may store power during an active (“on”) cycle for use on-site during an inactive (“off”) cycle. As another example, the electrical storage device 234 may have sufficient capacity to provide a “buffer” for peak electrical demands, so that the electric generator 230 output need only meet the average equipment requirements of the remote site. In some embodiments, the electric generator 230 charges the batteries (or other electrical energy storage apparatus) of the electrical storage device 234 and electrical power is supplied to the pressure differential power generating system 200 or to the external equipment 238 from the electrical storage device 234. In some embodiments, the pressure differential power generating system 200 and the external equipment 238 may receive electrical power from either the electric generator 230 or the electrical storage device 234. The electrical generator 230, the power conditioner 232, and the electrical storage device 234 are all grounded electrically as shown by electrical ground 236. Additionally, the mechanical equipment of the pressure differential power generating system 200, including the pressure differential turbine 210, the brake 212, and the clutches 216, 218, may be electrically grounded.

The controller 240 may control the clutch 218 according to a state-of-charge of the electrical storage device 234. When the state-of-charge of the electrical storage device 234 reaches or drops below a lower electric threshold (e.g., when the electrical storage device 234 is depleted), the clutch 218 may be actuated to couple (or re-couple) the electric generator 230 to the pressure differential turbine 210 output. Additionally, when the state-of-charge of the electrical storage device 234 reaches or exceeds an upper electric threshold (e.g., when the electrical storage device 234 is fully charged), the clutch 218 may be actuated to decouple the electric generator 230 from the pressure differential turbine 210 output. Decoupling may improve the lifespan of the electric generator 230 (as it is not constantly running) and the electrical storage device 234 (as it is not constantly charging). The upper and lower electric thresholds may be predetermined or may be dynamically selected. Additionally, the thresholds may be set by the manufacturer or may be set by the user (i.e., by the natural gas site operator). Where the electrical storage device 234 comprises a plurality of rechargeable batteries (or other electric power storage devices), the controller 240 may be configured to separately monitor and control the charging of each one of the rechargeable batteries. The clutch 218 may be actuated according to the needs of a single battery, a majority of the batteries, or all of the batteries, according to user preference and site needs. For example, the electric generator 230 may be decoupled from the pressure differential turbine 210 once the state-of-charge of each one of the batteries reaches the upper electric threshold or, alternatively, may be decoupled when the state-of-charge of any one of the batteries reaches the upper electric threshold. As another example, the electric generator 230 may be coupled to the pressure differential turbine 210 when the state-of-charge of each one of the batteries reaches the lower electric threshold or, alternatively, may be coupled when the state-of-charge of any one of the batteries reaches the lower electric threshold.

Mechanical power is transmitted from the pressure differential turbine 210 to the brake 212, the speed reduction device 214, the clutch 216, the clutch 218, the air compressor 220, and the electric generator 230 as shown by lines 211 (solid line pattern). Compressed air is distributed from the air compressor 220 to the compressed air storage device 222 and to external devices 224 as shown lines 221 (dashed and dotted line pattern). Electrical power is transmitted from the electric generator 230 and/or the electrical storage device 234 as shown by lines 231 (dashed line pattern). The compressed air lines (i.e., lines 221) and the electric power lines (i.e., lines 231) are collectively a power distribution system and may be separate from each other or may be co-located.

Although FIG. 2 shows actuators 242, 244, and 246 being supplied with electrical power via lines 231, in other embodiments the actuators 242, 244, and 246 may be supplied with compressed air. Additionally, external devices 224 and external equipment 238 may be the same or distinct entities. For example, certain equipment may require both electrical power and compressed air while other equipment may require only one of electrical power and compressed air. Thus the set of devices comprising external devices 224 may include one or more of external equipment 238 and the set of devices comprising external equipment 238 may include one or more of external devices 224.

In some embodiments, the pressure differential power generating system 200 may further include a temperature normalization subsystem (not shown) comprising a plurality of heat exchangers. For example, heat exchangers may draw heat from components that heat up during use and release said heat at the pressure differential turbine 210 as it cools down during use due to the expansion of natural gas. Examples of components that may heat up during use include, but are not limited to, the air compressor 220, the compressed air storage device 222, the electric generator 230, the electrical storage device 234, and the clutches 216, 218. The heat produced by these devices would be transferred to the expanded natural gas to offset the temperature drop cause by gas expansion. Alternatively, the temperature drop experienced by the expanding natural gas may be used to cool one or more of the air compressor 220, the compressed air storage device 222, the electric generator 230, the electrical storage device 234, and the clutches 216, 218.

FIG. 3A is a cut-away, perspective view of a natural gas pressure turbine assembly 300, according to embodiments of the disclosure. The natural gas pressure turbine assembly 300 may be similar to pressure turbine power generator 150 and may be used in an on-site power generation system (such as system 100) at a natural gas or oil field. The natural gas pressure turbine assembly 300 comprises a casing 310, an inlet 320, an outlet 330, a turbine impeller 340, and an output shaft 350. The casing 310 houses the components of the natural gas pressure turbine assembly 300 and provides a path for natural gas to flow from the high-pressure inlet 320 to the low pressure outlet 330 via the impeller 340. The casing 310 facilitates the expansion of the natural gas and the path directs the natural gas flow to the impeller 340. In some embodiments, such as embodiment of FIG. 3A, the natural gas pressure turbine assembly 300 may form a radial turbine, while in other embodiments the natural gas pressure turbine assembly 300 may form an axial turbine or other turbine arrangement. Where an axial turbine arrangement is used, the impeller 340 may be driven by lift as the natural gas flows past the impeller 340.

The casing 310 comprises an impeller chamber 312 for housing the impeller 340. The casing 310 allows the high pressure natural gas to expand and apply force to impeller 340. In some embodiments, the casing 310 allows the expanding natural gas to accelerate before reaching the impeller 340 and the velocity of the natural gas causes the impeller 340 to spin. In other embodiments, the expansion of natural gas due to the pressure differential between the inlet 320 and the outlet 330 causes the impeller 340 to spin. In certain embodiments, both the velocity and the pressure differential of the natural gas cause the impeller 340 to spin. The casing 310 may further comprise a volute chamber configured to convert pressure, from the high-pressure inlet stream, into velocity (i.e., kinetic energy). The casing 310 is configured to direct the natural gas stream into the impeller 340. Inlet 320 is connected to the upstream portion of the on-site power generation system and receives high pressure natural gas. In some embodiments, inlet 320 comprises a nozzle shaped to direct the high pressure natural gas stream towards the impeller 340. Outlet 330 is connected to the downstream portion of the on-site power generation system and outputs low pressure natural gas. The outlet 330 is positioned such that the natural gas stream must flow past and/or impact the impeller 340 before exiting the natural gas pressure turbine assembly 300.

The impeller, or turbine wheel, 340 comprises a plurality of blades used to convert energy of the natural gas into rotary motion. The impeller 340 is positioned between the volute chamber of the casing 310 and the outlet 330. The impeller 340 is connected to the output shaft 350 and rotation of the impeller 340 also causes the output shaft 350 to rotate. The impeller 340 is discussed in further detail below in reference to FIG. 3C.

The output shaft 350 is connected to the impeller 340 and extends beyond the casing 310. The output shaft 350 is used to deliver power to one or more power generating apparatus. In some embodiments, the output shaft 350 extends through the cover 360. In other embodiments, the output shaft may be indirectly coupled to the impeller 340, so that it does not pass through the cover 360.

In some embodiments, a pulley 352 may be attached to, or integrated with, the external end of the output shaft 350. A belt, chain, or other suitable device may attach to pulley 352, so that the rotation of output shaft 350 may be used to drive machinery, such as an air compressor or an electric generator. In other embodiments, a gear or sprocket is attached to the end of the output shaft 350 in lieu of the pulley 352. In yet other embodiments, the output shaft 350 attaches directly to a power generating apparatus. In some embodiments, the output shaft 350 comprises a gear reduction system, so that a high rate of rotation of the output shaft 350 may be reduced to more useful levels. For example, where the rotary power of the turbine is delivered to an electric generator, the high rate of turbine rotation (e.g., several hundred rotations per second) may be reduced to a rate corresponding to an AC frequency used on site (e.g., 60 Hz). As another example, where the rotary power of the turbine is delivered to a reciprocating (piston) air compressor, the high rate of turbine rotation may be reduced to a rate within the operating parameters of the air compressor. In certain embodiments, a clutch, or similar mechanism, is located between the output shaft 350 and a power generating apparatus (i.e., an air compressor), so that rotary power may be selectively delivered to the power generating apparatus. The clutch may be a part of the output shaft 350, a part of the power generating apparatus, or may exist as a separate component located between the output shaft 350 and the power generating apparatus.

In some embodiments, the natural gas pressure turbine assembly 300 comprises a cover 360 allowing disassembly of the natural gas pressure turbine assembly 300. The cover 360 may be removable to allow the impeller 340 and/or the output shaft 350 to be removed from the natural gas pressure turbine assembly 300 for maintenance and/or replacement. In some embodiments, a cover 360 is used to retain the impeller 340 in the casing 310. The cover 360 must maintain a tight seal against the turbine housing (e.g., casing 310) in order to prevent leakage of natural gas. The cover 360 may comprise a seal configured to prevent natural gas from leaking past the cover 360. The seal may be removable, to facilitate easy replacement, or may be integral to the cover 360.

While the embodiments of FIG. 3A show an output shaft 350 extending through the cover 360, in other embodiments the output shaft 350 does not extend through the cover 360. In such embodiments, the output shaft 350 is located outside the turbine body (i.e. outside of the casing 310 and the cover 360) and is magnetically coupled to the impeller 340. The magnetic coupling allows the rotary motion of the impeller 340 to be transferred to one or more power generators via output shaft 350 while maintaining a strong seal against natural gas leakage. A magnetic coupling arrangement is less susceptible to leaks than arrangements where the output shaft 350 extends through the cover 360.

FIG. 3B is an external, perspective view of the natural gas pressure turbine assembly 300. As shown in FIG. 3B, in some embodiments natural gas pressure turbine assembly 300 may form radial turbine, such as a 90 degree inward flow radial turbine. In such embodiments, the casing 310 may comprise a volute chamber to facilitate the expansion of the high pressure natural gas. A natural gas stream enters the natural gas pressure turbine assembly 300 through inlet 320, turns the impeller 340, and exits through the outlet 330. The impeller 340 is connected to the output shaft 350 that drives a power generating apparatus, such as an air compressor or an electrical generator.

FIG. 3C is a perspective view of an impeller 340 for a natural gas pressure turbine assembly 300 according to embodiments of the disclosure. The impeller 340 is rotatable within the casing 310 and comprises a plurality of blades 342 attached to a hub 344. The plurality of blades extends radially inward from the periphery of the impeller 340. In some embodiments, the blades 342 are aerodynamically optimized for converting the force exerted by the natural gas stream. As shown in FIG. 3C, the blades 342 may be of different sizes and geometries. In some embodiments, the impeller 340 may be configured for a radial turbine, such as the 90 degree inward flow radial turbine shown in FIGS. 3A and 3B. In other embodiments, the impeller 340 may be configured for an axial flow turbine. Additionally, the plurality of blades may be configured according to the pressure and/or flow objectives for a particular natural gas pressure turbine. In some embodiments, the blades 342 comprise variable blades that may be adjusted dynamically to optimize performance of the turbine 300. For example, as natural gas is removed from a reservoir the pressure of the extracted natural gas may drop. As the pressure differential decreases over the life of the natural gas site, the variable blades 342 may be adjusted to compensate for the changed eased pressure differential, so as to optimize the performance of the turbine 300.

As the natural gas flows through the turbine casing 310, it impels upon the blades 342 transferring energy to the impeller 340 causing the impeller 340 to rotate about the hub 344 within the turbine casing 310. The hub 344 may comprise an output shaft, or it may be connected to an output shaft, such as output shaft 350, so that the rotary motion of the impeller 340 may be used to power machinery.

FIG. 4 is a view of a pressure differential power generating system 400, according to embodiments of the disclosure. The pressure differential power generating system 400 may be similar to the pressure turbine power generator 150 discussed above with reference to FIG. 1. The pressure differential power generating system 400 comprises a pressure differential turbine 410, a connector 430, and a power generating apparatus 440. The pressure differential turbine 410 may be similar to the natural gas pressure turbine assembly 300 discussed above with reference to FIGS. 3A-3C. The pressure differential turbine 410 comprises an inlet 412 for receiving high pressure natural gas, an expansion chamber 414 for expanding the high pressure natural gas, a turbine wheel 420 that spins due to the expansion of the high pressure natural gas, and an outlet 416 for delivering the resulting low pressure gas downstream. The turbine wheel 420 is configured to produce mechanical, rotary motion from the pressure differential and/or velocity of the natural gas. The turbine wheel 420 delivers the rotary motion (mechanical power) to the connector 430 via an output shaft 422. The connector 430 is connected to the pressure differential turbine 410 via output shaft 422 and to the power generating apparatus 440. The connector 430 may comprise one or more of a clutch, a gearbox, a belt and pulley, a chain, and a transmission system. The power generating apparatus 440 may comprise an air compressor, an electric generator, or a hydraulic pump. The power generating apparatus converts rotary motion from the pressure differential turbine into on-site power in the form of, e.g., electricity or compressed air.

While the embodiment of FIG. 4 shows one pressure differential turbine 410 and one power generating apparatus 440, in other embodiments one or more pressure differential turbines 410 may drive one or more power generating apparatus 440. For example, a plurality of pressure differential turbines 410 may drive a single power generating apparatus 440 where the connector 430 comprises a transmission with one or more differentials for delivering mechanical power from the turbines 410 to the power generating apparatus 440. As another example, a single pressure differential turbine 410 may simultaneously drive a plurality of power generating apparatus 440 (e.g., an air compressor and an electric generator) where the connector 430 comprises a transmission that connects each power generating apparatus 440 to the pressure differential turbine.

FIGS. 5A-5B are views of a pressure differential power generating system 500, according to embodiments of the disclosure. FIG. 5A is a perspective view of the pressure differential power generating system 500, while FIG. 5B is an exploded, perspective view of the pressure differential power generating system 500. The pressure differential power generating system 500 may be similar to the pressure turbine power generator 150 and/or the pressure differential power generating system 400 discussed above with reference to FIGS. 1 and 4. The pressure differential power generating system 500 utilizes a pressure differential in a natural gas delivery system to generate on-site power for a natural gas site or oil field.

The pressure differential power generating system 500 comprises a pressure differential turbine housing 510, a turbine wheel 520, a stator 525, a cover 530, a drive shaft 535, an alternator 550, and an air compressor 560. The pressure differential turbine housing 510 houses the components of the pressure differential turbine housing 510 and provides a path for natural gas to flow from the high-pressure inlet pipe 540 to the low pressure outlet pipe 545. The pressure differential turbine housing 510 forms a 90 degree, inward flow radial turbine and comprises an expansion chamber 515 that receives high pressure natural gas via an inlet pipe 540. The inlet pipe 540 is connected to the upstream portion of the on-site power generation system and comprises a passageway leading from a side of the pressure differential turbine housing 510 to an expansion chamber 515. In some embodiments, the inlet 540 may further comprise a nozzle for increasing the velocity of the natural gas and/or directing the natural gas stream at the turbine wheel 520. After transferring energy to the turbine wheel 520, the lower pressure natural gas flows past the stator 525 and out of the pressure differential turbine housing 510 via outlet pipe 545. The stator 525 comprises a set of stationary vanes for directing the natural gas into the outlet pipe 545. The stator 525 may also reduce the velocity (and consequently increase the pressure) of the natural gas before it enters the outlet pipe 545. Outlet pipe 545 is connected to the downstream portion of the on-site power generation system. The outlet pipe 545 is positioned, so that the natural gas stream must flow past and/or impact the turbine wheel 520 before exiting the pressure differential turbine housing 510.

The expansion chamber 515 defines a cavity configured to hold the turbine wheel 520. In some embodiments, the expansion chamber 515 is shaped to fit tightly around the turbine wheel 520. The turbine housing 510 allows the high pressure natural gas to expand and apply force to turbine wheel 520. The pressure differential between the inlet 540 and the outlet 545 causes the turbine wheel 520 to spin as the natural gas passes through the expansion chamber 515. The turbine wheel may be primarily driven by pressure differential (e.g., expansion of natural gas), it may be primarily driven by the velocity of the expanding natural gas, or it may be driven by both the pressure differential and the velocity of the natural gas. The expansion chamber 515 is configured to direct expanding and/or expanded natural gas into the turbine wheel 520. While in some embodiments, such as embodiment of FIG. 5B, the pressure differential turbine housing 510 may form a radial turbine, in other embodiments the pressure differential turbine housing 510 may form an axial turbine or other turbine arrangement. Where an axial turbine arrangement is used, the turbine wheel 520 may be driven by lift as the natural gas flows past the turbine wheel 520.

The turbine housing 510 may be shaped to allow the expanding natural gas to accelerate before reaching the turbine wheel 520 and the velocity of the natural gas causes the turbine wheel 520 to spin. In certain embodiments, the expansion chamber 515 may comprise a volute chamber, in the shape of a volute, configured to convert pressure, from the high-pressure natural gas, into kinetic energy, which is then transferred to the turbine wheel 520. For example, the expansion chamber 515 may be shaped to cause the expanding natural gas to develop a higher velocity. The expansion chamber 515 is further configured to direct the higher velocity natural gas into the turbine wheel 520, causing the turbine rotor to spin. In some embodiments, the expansion chamber 515 comprises a nozzle for accelerating the high pressure natural gas and directing the flow at the turbine wheel 520.

The turbine wheel 520 is rotatable in the expansion chamber 515 and has a plurality of blades extending at least radially inward from the periphery of the turbine wheel 520. The blades are used to convert energy of the natural gas into rotary motion. The turbine wheel 520 is connected to the output shaft 535 and rotation of the turbine wheel also causes the output shaft 535 to rotate. The turbine wheel 520 may be similar to turbine wheel 520 discussed above with reference to FIGS. 3A-3C

The output shaft 535 is connected to the turbine wheel 520 and extends beyond the turbine housing 510 through the cover 530. The output shaft 535 is used to deliver power to the alternator 550 and the air compressor 560.

The cover 530 contains the natural gas within the pressure differential turbine housing 510 and attaches to the housing 510 via a plurality of attachment points 536. In some embodiments, cover 530 may be removable to allow access to the turbine wheel 520 and/or the output shaft 535. The cover 530 comprises an opening through which the output shaft 535 passes. The cover 530 maintains a tight seal against the turbine housing (e.g., turbine housing 510) in order to prevent leakage of natural gas. The cover 530 comprises a bearing seal 532 configured to prevent natural gas from leaking through the output shaft opening. The bearing seal is placed between the output shaft 535 and the cover 530 and surrounds the output shaft 535. The bearing seal 532 comprises a plurality of bearings and/or friction reducing friction to minimize friction between the stationary cover 530 and the rotating output shaft 535.

In some embodiments, a pulley or sprocket may be attached to, or integrated with, the external end of the drive shaft 535. A belt, chain, or other suitable device may attach to the pulley (or sprocket) to transfer the rotation of drive shaft 535 to an alternator shaft 555 of the alternator 550 and a compressor shaft 565 of the compressor 560. The drive shaft 535 may comprise a gearing system to decrease, or increase, the rate of rotation of the drive shaft 535 to more useful levels. For example, the rate of the drive shaft 535 may be changed to a rate corresponding to an AC frequency used on site (e.g., 60 Hz). In certain embodiments, a clutch, or similar mechanism, is located between the drive shaft 535 and a power generating apparatus (i.e., the alternator 550 or the air compressor 560), so that rotary power may be selectively delivered to the power generating apparatus. The clutch may be a part of the drive shaft 535, a part of the power generating apparatus, or may be a separate component located between the drive shaft 535 and the power generating apparatus.

The alternator 550 is configured to convert mechanical power (i.e., rotary motion) received at the alternator shaft 555 from the output shaft 535 to generate electric power (i.e., electricity). The waveform, voltage, and/or current of the generated electric power may be selected according to the requirements of the natural gas (or oil) site. In some embodiments, the alternator may comprise a power conditioner configured to transform the waveform, voltage, and/or current of the electrical power generated by the alternator 550 into forms usable at the remote site. For example, pressure transducers may require relatively low voltages and currents while processing equipment may require much higher voltages and currents. Accordingly, the alternator 550 may be configured to generate the high voltages and currents required by the processing equipment, while the power conditioner adapts some of the high voltage, high current electrical power into the lower voltage and current power used by the pressure transducers. The alternator 550 may be similar to electric generator 230 discussed above with reference to FIG. 2.

The alternator 550 may be electrically connected to one or more batteries, capacitors, or other electrical energy storage apparatus. The alternator 550 may be configured to charge the batteries, etc., and electrical power is supplied to the remote site from the electrical energy storage apparatus. When the electrical storage device 234 is fully charged, a clutch decouples the alternator 550 from the output shaft 535, so that the alternator 550 is not constantly running.

Air compressor 560 is configured to use mechanical power (i.e., rotary motion) received at the alternator shaft 565 from the output shaft to compress air. Compressed air is transferred to an air storage tank, which stores the compressed air for use at the remote site. The pressure of air generated by the air compressor 560 may be determined by the needs of the remote site and/or the capabilities of the air storage tank. In some embodiments, the pressure levels generated by the air compressor 560 are adjustable. For example, the pressure levels may be computer controlled and dynamically adjustable.

The alternator 550 is located adjacent to the pressure differential turbine housing 510 and attaches to the pressure differential turbine housing 510 via alternator bracket 552. Alternator bracket 552 is a mounting bracket sized to fit the alternator 550 and configured to hold the alternator 550 steady against the pressure differential turbine housing 510. Similarly, the compressor 560 is also located adjacent to the pressure differential turbine housing 510 and attaches to the pressure differential turbine housing 510 via compressor bracket 562. The compressor bracket 562 is a mounting bracket sized to fit the compressor 560 and configured to hold the compressor 560 steady against the pressure differential turbine housing 510.

The pressure differential power generating system 500 may be monitored and controlled by a computer device. The computer device may comprise one or more microprocessors, programmable logic devices, integrated circuits, or other controllers. The computer device may comprise computer-readable memory (volatile and/or non-volatile) or other data storage devices that hold instructions for operating the pressure differential power generating system 500 and parameters or data associated with the operation of the pressure differential power generating system 500. For example, the computer device may comprise non-transitory computer readable storage media, including, but not limited to, random access memory (RAM), read-only memory (ROM), flash memory, magnetic storage devices—such as floppy discs or hard-disc drives, and optical storage devices—such as compact discs (CDs), video discs (e.g., DVDs), and holographic storage devices. The computer-readable memory may contain software, firmware, and data structures necessary for the operation of the pressure differential power generating system 500. Further, the computer-readable memory may store data relating to the performance of the components of the pressure differential power generating system 500.

FIG. 6 is a perspective view of a pressure differential power generating system 600 comprising a natural gas pressure turbine having a magnetic coupling mechanism according to embodiments of the disclosure. The magnetic coupling allows the rotary motion of the turbine wheel to be transferred through the cover to one or more power generators without needing a hole or opening in the cover to permit a shaft, belt, chain, or other mechanism to pass through. The power generating system 600 comprises a pressure differential turbine housing 610, a turbine rotor 620, a stator 625, a cover 630, a drive shaft 635, a first magnetic coupler 650, and a second magnetic coupler 655. High pressure natural gas flows into the pressure differential turbine housing 610 via an inlet pipe 640. The inlet 640 comprises a passageway leading from a side of the pressure differential turbine housing 610 to an expansion chamber 615. In some embodiments, the inlet 640 may further comprise a nozzle for increasing the velocity of the natural gas and directing the natural gas stream at the turbine rotor 620. After passing through the expansion chamber 615, and decreasing in pressure, the lower pressure natural gas flows out of the pressure differential turbine housing 610 via outlet pipe 645. Before exiting the pressure differential turbine housing 610, the natural gas flows through the stator 625, a set of stationary vanes for directing the natural gas into the outlet pipe 645. The stator 625 may also reduce the velocity (and consequently increase the pressure) of the natural gas before it enters the outlet pipe 645.

The expansion chamber 615 defines a rotor cavity configured to hold the turbine rotor 620. In some embodiments, the expansion chamber 615 is shaped to fit tightly around the turbine rotor 620. The pressure differential between the inlet 640 and the outlet 645 causes the turbine rotor 620 to spin as the natural gas passes through the expansion chamber 615. The expansion chamber 615 is configured to direct expanding and/or expanded natural gas into the turbine rotor 620.

In certain embodiments, the expansion chamber 615 may comprise a volute chamber configured to convert pressure, from the high-pressure natural gas, into kinetic energy, which is then transferred to the turbine rotor 620. For example, the expansion chamber 615 may be shaped to cause the expanding natural gas to develop a higher velocity. The expansion chamber 615 is further configured to direct the higher velocity natural gas into the turbine rotor 620, causing the turbine rotor to spin. In some embodiments, the expansion chamber comprises a nozzle for accelerating the high pressure natural gas and directing the flow at the turbine rotor 620.

The turbine rotor 620 is rotatable in the expansion chamber 615 and has a plurality of blades extending at least radially inward from the periphery of the turbine rotor 620. The turbine rotor 620 may be similar to impeller 340 and/or turbine wheel 520 discussed above with reference to FIGS. 3A-3C and 5A-5B.

The turbine rotor 620 is connected to the first magnetic coupler 650. The first magnetic coupler 650 is located within the pressure differential turbine housing 610 and may be exposed to natural gas flowing through the expansion chamber 615. The first magnetic coupler 650 is also located adjacent to the cover 630, although the first magnetic coupler 650 may not touch the cover 630 to minimize friction. In some embodiments, a plurality of bearings may be located on the first magnetic coupler 650 and/or the cover 630 to minimize friction from contact between the first magnetic coupler 650 and the cover 630. Because the first magnetic coupler 650 is mechanically linked to the turbine rotor 620, the first magnetic coupler 650 rotates at the same rate as the turbine rotor 620.

The first magnetic coupler 650 is magnetically coupled to the second magnetic coupler 655. The second magnetic coupler 655 is located adjacent to the cover 630, to minimize the distance between the first and second magnetic couplers 650, 655. The second magnetic coupler 655 is positioned to avoid contact with the cover 630; however, in some embodiments a plurality of bearings may be located on the second magnetic coupler 655 and/or the cover 630 to minimize friction from accidental contact between the second magnetic coupler 655 and the cover 630. The second magnetic coupler 655 is magnetically coupled to the first magnetic coupler 650, so that the second magnetic coupler 655 rotates at the same rate as the first magnetic coupler 650 (and the turbine rotor 620).

The drive shaft 635 is connected to the second magnetic coupler 655 and is used to drive one or more power generating apparatus. In some embodiments, the drive shaft 635 attaches directly to a power generating apparatus. In other embodiments, a pulley or sprocket may be attached to, or integrated with, the external end of the drive shaft 635. A belt, chain, or other suitable device may attach to the pulley or sprocket, so that the rotation of drive shaft 635 may be used to drive machinery such as an air compressor or an electric generator. The drive shaft 635 may comprises a gearing system to decrease, or increase, the rate of rotation of the drive shaft 635 to more useful levels. For example, the rate of the drive shaft 635 may be changed to a rate corresponding to an AC frequency used on site (e.g., 60 Hz).

In certain embodiments, a clutch, or similar mechanism, is located between the drive shaft 635 and a power generating apparatus (i.e., an air compressor), so that rotary power may be selectively delivered to the power generating apparatus. The clutch may be a part of the drive shaft 635, a part of the power generating apparatus, or may exist as a separate component located between the drive shaft 635 and the power generating apparatus. In some embodiments, the second magnetic coupler 655 may comprise one or more electromagnets that can be selectively activated and perform the function of a clutch. The drive shaft 635 may also comprise brake used to reduce the speed of the drive shaft 635 should the rate get too high or to shut down the pressure differential power generating system 600 in the event of an emergency.

The cover 630 contains the natural gas within the pressure differential turbine housing 610. In some embodiments, the cover 630 is used to retain the turbine rotor 620 and the first magnetic coupler 650 is within the pressure differential turbine housing 610. The cover 630 maintains a tight seal against the pressure differential turbine housing 610 in order to prevent leakage of natural gas. Because the cover 630 lacks an opening for an output shaft to pass through, the embodiment of FIG. 6 is less susceptible to leaks than the embodiments of FIGS. 5A-5B.

FIGS. 7A-7F are views of a pressure differential turbine body 700, according to embodiments of the disclosure. The pressure differential turbine body 700 may be similar to natural gas pressure turbine casing 310, pressure differential turbine housing 510, and/or pressure differential turbine housing 610 discussed above with reference to FIGS. 3A-3C, 5A-5B, and 6.

The pressure differential turbine body 700 comprises a plurality of mounting units 702, expansion cavity 710, inlet 712, and outlet 714. The mounting units 702 allow for mounting a cover (e.g., one of covers 360, 530, or 630) onto the pressure differential turbine body 700. The inlet 712 comprises a passageway leading from a side of the pressure differential turbine body 700 to the expansion cavity 710. Higher pressure natural gas enters the pressure differential turbine body 700 via the inlet 712. Outlet 714 comprises a passageway leading from the expansion cavity 710 to another side of the pressure differential turbine body 700. Lower pressure natural gas exits the pressure differential turbine body 700 via the outlet 714. Inlet 712 and outlet 714 are on different sides of the pressure differential turbine body 700. For example, inlet 712 may be on a side that is at a 90° angle to the outlet 714 side.

The expansion cavity 710 is configured to hold a turbine wheel. Natural gas enters the expansion cavity 710 via inlet 712 and must flow past the turbine wheel before exiting via outlet 714. The pressure differential between the inlet 712 and the outlet 714 causes the turbine wheel to spin as the natural gas passes through the expansion cavity 710. In some embodiments, the expansion cavity 710 is shaped to allow the higher pressure natural gas to expand, so that it can drive the turbine wheel. For example, the expansion cavity 710 may comprise a nozzle adjacent to inlet 712 for accelerating the natural gas as it flows into the expansion cavity 710. In some embodiments, the natural gas may develop kinetic energy, which is then transferred to the turbine wheel. For example, the expansion cavity 710 may comprise a volute chamber for accelerating the natural gas and directing the flow into the turbine wheel. In some embodiments, the expansion cavity 710 is shaped to fit tightly around the turbine wheel. For example, the expansion cavity 710 may be shaped to prevent the natural gas from exiting the turbine body 700 without impacting the turbine wheel.

FIG. 7A is a front view of the pressure differential turbine body 700 according to embodiments of the disclosure. Lines A1, A2, B1, and B2 bisect the pressure differential turbine body 700 at various locations. FIGS. 7B-7E are cut-away views along the lines A1, A2, B1, and B2. FIG. 7B is a cut-away, side view of the pressure differential turbine body 700 along line A1. FIG. 7C is a cut-away, side view of the pressure differential turbine body 700 along line A2. FIG. 7D is a cut-away, side view of the pressure differential turbine body 700 along line B1. FIG. 7E is a cut-away, side view of the pressure differential turbine body 700 along line B2. FIG. 7F is a perspective view of the pressure differential turbine body 700, according to embodiments of the disclosure.

FIG. 8 is a block diagram of a system 800 for generating power from pressurized natural gas in a flare line according to embodiments of the disclosure. The system 800 is located at a natural gas field and may be similar to system 100 discussed with reference to FIG. 1 above. The system 800 comprises a well 810, a separation tower 820, a production unit 830, backpressure control valves 826 and 840, a pressure turbine power generator 850, and a flare 870. The system 800 comprises a power distribution grid 855 used to distribute power generated by the pressure turbine power generator 850 to the well 810, the separation tower 820, and/or the production unit 830. Natural gas is extracted from underground deposits using the well 810. While the discussion of FIG. 8 generally assumes that natural gas and associated liquids (e.g., ethane, propane, butane, etc.) are extracted from the well 810, in other embodiments crude oil and associated natural gas may be extracted from the well 810. After extraction and separation, saleable products (i.e., natural gas liquids, crude oil, etc.) are transported via pipeline to processing facility 860.

The separation tower 820 is configured to separate the gaseous products extracted from the well 810 (e.g., natural gas) from the liquid products extracted by the well 810 (e.g., natural gas liquids). In some embodiments, the separation tower 820 may also be configured to remove liquid water and/or water vapor. The production unit 830 may be configured to separate condensates and/or impurities (e.g., water, carbon dioxide, or other compounds) from the natural gas liquids. In some embodiments, the production unit 830 separates and/or extracts various hydrocarbons, including natural gas liquids such as methane, butane, etc. While the discussion of FIG. 8 assumes a separate production unit 830 located downstream of the separation tower 820, the functions of the production unit 830 may be distributed among various locations. For example, impurities may be removed before the oil or condensates are separated from the natural gas at separation tower 820. In yet other embodiments, the separation tower 820 and the production unit 830 are co-located, so that both separation and processing occur at the same facility.

The natural gas liquids (and/or oil) leave the remote site and are transported to processing facility 860 via sales line 862. The sales line 862 is a transportation pipeline for carrying the transporting natural gas liquids (and/or oil) that comprises a sales meter for determining the amount of product (e.g., natural gas liquids) produced by the remote site and placed into the sales line 862. The processing facility 860 may be a refinery, cryogenic facility, compressor station, or distribution center. The processing facility 860 receives the natural gas liquids or other product and prepares it for commercial distribution similar to the processing facility 160 described above with reference to FIG. 1.

The system 800 further comprises a plurality of natural gas pipelines 812 used to transport oil between components of the system 800. The system also comprises a flare line 872 for transporting natural gas to the flare 870 where it is burned. While FIG. 8 shows a flare line leading from the separation tower 820, the system 800 may include flare lines leading from the wellhead 810 and/or the production unit 830. In some embodiments, waste natural gas is released into the flare lines. In some embodiments, natural gas may be released via pressure relief valves whenever the well 810, the separation tower 820, or the production unit 830 become over-pressured. The pressure turbine power generator 850 is placed on the flare line 872 to extract power from the expansion of pressurized natural gas vented into the flare line (e.g., via a pressure relief valve). Additionally, while FIG. 8 shows the system 800 comprising a single pressure turbine power generator 850, in some embodiments the system 800 comprises more than one pressure turbine power generators. For example, the system 800 may comprise the pressure turbine power generator 850 connected to the flare line 872 and an additional natural gas pressure turbine connected to the backpressure control valve 840. As another example, the illustrated pressure turbine power generator 850 may comprise two or more pressure turbine power generators arranged in series or in parallel.

The backpressure control valves 826 and 840 are control valves or regulators configured to maintain a certain upstream pressure in the system 800. In some embodiments, the backpressure control valves 826 and 840 ensure that the separation and processing of natural gas, natural gas liquids, and/or crude oil occur at a particular pressure level.

The pressure turbine power generator 850 may be similar to the pressure turbine power generator 150 discussed with reference to FIGS. 1, 4, 5A-5B, and 6 above. The pressure turbine power generator 850 generates power from the expansion of natural gas as it passes from a high-pressure region to a low-pressure region. The pressure turbine power generator 850 does not combust the natural gas to generate power and neither natural gas nor combustion byproducts are released into the atmosphere by the pressure turbine power generator 850. Instead, the pressure turbine power generator 850 harnesses the pressure differential between the inlet and outlet of the natural gas pressure turbine 850 to spin the turbine blades thereby generating power while delivering the natural gas to the flare 870.

The pressure turbine power generator 850 may generate mechanical and/or electrical power. For example, the pressure turbine power generator 850 may drive an air compressor for producing compressed air for use in the system 800 and/or an electric generator. The compressed air and/or generated electricity may be used on site to supplement and/or replace conventionally power delivery to the system 800 (e.g., via natural-gas fired generators, solar panels, wind turbines, and the like). In certain embodiments, the pressure turbine power generator 850 drives a hydraulic pump used to power pumps or other machinery. In some embodiments, the pressure turbine 850 power generator drives two or more of: an electrical generator, a hydraulic pump, and an air compressor.

In some embodiments, excess power generated by the pressure turbine power generator 850 is stored in power storage device 852. The power storage device 852 may comprise batteries and/or capacitors for storing electrical power. Alternatively, or additionally, the power storage device may comprise one or more tank for holding compressed air. The power storage device 852 allows the system 800 to use larger amounts of electricity or compressed air than the instantaneous output of the pressure turbine power generator 850.

While the systems 100 and 800 discussed above with reference to FIGS. 1 and 8 disclose a pressure turbine power generator located at the remote site, also within the scope of the invention are embodiments where a pressure turbine power generator is located on the sales line (e.g., sales line 162 or 862) and between compressor stations. A natural gas transportation pipeline typically includes one or more compressor stations, also known as pumping stations, which helps the transportation process of natural gas from one location to another. Natural gas in the transportation pipeline is regularly re-pressurized at intervals of 40 to 100 miles, depending on terrain and the number of gas wells feeding into the pipeline. A pressure turbine power generator located on the transportation pipeline could convert excess pressure in the pipeline into electricity to be sold back to the electrical power system (power grid).

It will be obvious to those having skill in the art that many changes may be made to the details of the above-described embodiments without departing from the underlying principles of the invention. The scope of the present invention should, therefore, be determined only by the following claims.

1. A system for generating on-site power at a natural gas field, the system comprising:
a natural gas well for extracting natural gas;
one or more processing facilities connected to the natural gas well and configured to separate liquids from the natural gas;
a natural gas pressure turbine configured to receive the natural gas from the one or more processing facilities and generate mechanical power by expanding the natural gas, wherein the natural gas pressure turbine outputs the natural gas after expansion;
an air compressor connected to the natural gas pressure turbine and configured to generate compressed air from the mechanical power; and
a distribution system connected to the air compressor, wherein the distribution system provides the compressed air from the air compressor to the one or more processing facilities.

2. The system of claim 1, further comprising:
an electric generator configured to generate electrical power from the mechanical power; and
a generator clutch located between the natural gas pressure turbine and the electric generator, the generator clutch configured to selectively decouple the electric generator from the mechanical power generated by the natural gas pressure turbine,
wherein the distribution system is configured to deliver the electrical power from the electric generator to the natural gas well.

3. The system of claim 1, further comprising a compressor clutch located between the natural gas pressure turbine and the air compressor, the compressor clutch configured to selectively decouple the air compressor from the mechanical power generated by the natural gas pressure turbine.

4. The system of claim 1, further comprising a processor configured to monitor the natural gas pressure turbine, the air compressor, and an air storage device configured to store the generated compressed air.

5. The system of claim 4, wherein the processor is further configured to monitor a pressure level of the air storage device and to actuate a compressor clutch to decouple the air compressor from the natural gas pressure turbine when the pressure level of the air storage device is at or above a predetermined upper air threshold.

6. The system of claim 5, wherein the processor is further configured to actuate the compressor clutch to couple the air compressor to the natural gas pressure turbine when the pressure level of the air storage device is at or below a predetermined lower air threshold.

7. The system of claim 6, wherein the air storage device comprises a plurality of air tanks and wherein the processor is configured to separately monitor and control filling of each one of the plurality of air tanks.

8. The system of claim 4, wherein the processor is further configured to monitor a state-of-charge of an electric power storage device and to actuate a generator clutch to decouple an electric generator from the natural gas pressure turbine when the state-of-charge of the electric power storage device is at or above a predetermined upper electric threshold.

9. The system of claim 8, wherein the processor is further configured to actuate the generator clutch to couple the electric generator to the natural gas pressure turbine when the state-of-charge of the electric power storage device is at or below a predetermined lower electric threshold.

10. The system of claim 9, wherein the electric power storage device comprises a plurality of rechargeable batteries and wherein the processor is configured to separately monitor and control charging of each one of the plurality of rechargeable batteries.

11. The system of claim 1, wherein the natural gas turbine comprises a turbine wheel and a drive shaft, wherein the turbine wheel is magnetically coupled to the drive shaft.

12. The system of claim 2, further comprising a power conditioner electrically connected to the electric generator and configured to adapt a first voltage, a first current, or a first waveform of the electric power generated by the electric generator into a second voltage, a second current, or a second waveform useable by the on-site equipment.

13. (canceled)

14. A method for generating on-site power, the method comprising:
extracting natural gas using a natural gas well;
separating associated liquids from the natural gas using a processing facility;
drying the natural gas;
sending the natural gas to a pressure differential turbine;
extracting mechanical power, via the pressure differential turbine, from a pressure differential of the natural gas, wherein the pressure differential turbine outputs the natural gas after extracting the mechanical power;
generating electrical power from the extracted mechanical power;
producing compressed air from the extracted mechanical power;
distributing the electrical power to the natural gas well; and
providing the compressed air to the processing facility.

15. The method of claim 14, wherein the compressed air is produced by an air compressor coupled to the pressure differential turbine and wherein excess compressed air is stored in an air storage device, the method further comprising:
monitoring a pressure level of the air storage device; and
decoupling the air compressor from the natural gas pressure turbine when the pressure level of the air storage device is at or above a predetermined upper air threshold; and
coupling the air compressor to the natural gas pressure turbine when the pressure level of the air storage device is at or below a predetermined lower air threshold.

16. The method of claim 14, wherein the electrical power is generated by an electric generator and wherein excess electrical power is stored in an electric power storage device, the method further comprising:
monitoring a state-of-charge of the electric power storage device; and
decoupling the electric generator from the natural gas pressure turbine when the state-of-charge of the electric power storage device is at or above a predetermined upper electric threshold; and
coupling the electric generator to the natural gas pressure turbine when the state-of-charge of the electric power storage device is at or below a predetermined lower electric threshold.

17. The method of claim 14, further comprising adapting an electrical input into an electrical output, wherein the electrical input varies from the electrical output in at least one of voltage, current, and waveform.

18. The method of claim 14, wherein the extracted mechanical power comprises rotary motion having a first rate of speed, the method further comprising reducing the first rate of speed to a second rate of speed.

19. The method of claim 14, wherein the electrical power is generated by an electric generator, the method further comprising exchanging heat between the electric generator and the natural gas pressure turbine.

20. A pressure differential power generating apparatus for generating on-site power at a natural gas field, the apparatus comprising:
a natural gas pressure turbine configured to receive pressurized natural gas from a natural gas well and to generate mechanical power by expanding the natural gas, wherein the natural gas pressure turbine outputs the natural gas after expansion;
an electric generator connected to the natural gas pressure turbine and configured to generate electrical power from the mechanical power; and
a distribution system configured to deliver the electrical power from the electric generator to the natural gas well.

21. The system of claim 1, wherein the natural gas pressure turbine outputs the expanded natural gas into a sales line.
